(19) United States
(12) Patent Application Publication
(10) Pub. No.: US 2003/0115278 A1
(43) Pub. Date: Jun. 19, 2003

(54) Method and system for personalizing content to be delivered to a group factoring into account individual interests of each group member

(76) Inventor: Mehmet H. Goker, Menlo Park, CA (US)

Correspondence Address: CROWELL & MORING, LLP, P.O. Box 14300, Washington, DC, 20044-4300, US

(21) Appl. No.: 10/013,836

(22) Filed: Dec. 13, 2001

(51) Int. Cl. G06F 15/16

(52) U.S. Cl. 709/207

(57) ABSTRACT

A method and system are provided for selecting content personalized for a group of members. The content is characterized by various attributes. Individual interest values of each group member for the various attributes is determined. The individual interest values are then compiled into a virtual group member. The content for the group of members that best fits the virtual group member is selected and delivered to the group of members.

### FIELD OF THE INVENTION

The invention relates to the field of dynamic interest compilation for delivering personalized content and service information to a member of a group.

### BACKGROUND OF THE INVENTION

In the field of dynamic interest compilation, it is known that communities of users (members) can be based on a shared interest or location (either physical or virtual). For user groups where the common shared interest is known, this information can be used to select appropriate content or provide suitable services. However, in situations where a user group is only determined by its proximity to a certain location that is not necessarily related to the individual interests of the users in the group, providing services in a most effective way becomes more difficult.

In cases where the common interest of a community of users is not known in advance, the information known regarding the people sharing the same location can be used to distill and provide content and services that may be of interest to the majority of people at that location. For example, the content displayed on billboards can be adjusted to the interests of the drivers passing by, and offers and services can be customized similarly.

Referring to prior art FIG. 1, in this situation involving billboards 12-14 located at the side of a road 11, regardless of whatever the interests of the drivers 10 may be, they will always see the same material displayed on the billboards 12-14. The billboard advertising is indifferent to their individual interests. The same is true for any situation where a group of people shares a location and the environment cannot or does not take their interest into account. A bar were the music is not adjusted in accordance with the clientele, a restaurant with an ill-adjusted air conditioning system or even TV programs that do not take the interests of their viewers into account are examples of this phenomenon.

Known systems that acquire the user's interests and preferences and adapt themselves accordingly are called “user adaptive” or “personalized” systems. These known systems primarily focus on determining the interest of individual users and generating, filtering and delivering content suitable to the particular individual user.

Known personalized systems obtain user preferences through interactions with users. These preferences are summarized in a user model and the user model is utilized to adapt the system to generate customized information or behavior. A flow chart of the personalization cycle in such a known system is illustrated in prior art FIG. 2. The system then delivers customized information in the manner that is most desirable for the current user, thereby increasing the quality of both the interaction and the generated result.

Known user models can represent stereotypical users or individuals, they can be handcrafted or learned (from questionnaires, ratings, or usage traces), and they can contain information about previously selected items, preferences regarding item characteristics, or properties of the users themselves. These various approaches are complementary, but in practice developers usually choose only one approach to create their user model.

In terms of actually acquiring user models, there are two broadly distinguishable basic approaches. The direct-feedback approach places the burden on the user by soliciting preference information directly from the user. One standard approach is to ask the user to complete a preferences form by classifying or weighting their interests using a range of interest categories. The problem with this approach is that users are usually put off by the need to complete long questionnaires before they can even begin to enjoy a given service. In response, another form of direct-feedback encourages the user to provide feedback as they use a particular service, and on an on-going basis. An example of such a system is PTV, a system that generates personalized TV listings.

The second basic approach to acquiring user models is to derive user preferences unobtrusively, by mining the interactions with the user. An example of such a system for generating personalized destination advice is described in the article “Personalized, Conversational Case-Based Recommendation”, Goeker M., Thompson C. (2000), pp. 99-111, in E. Blanzieri and L. Portinale (eds.), “Advances in Case-Based Reasoning, Proceedings, 5^{th} European Workshop on Case-Based Reasoning, Trento, Italy, Sep. 6-9, 2000”.

Ultimately, personalization techniques are concerned with utilizing a learned user profile in order to identify and present (recommend) relevant information to the right user at the right time. In general two broad strategies are known: a content-based approach that seeks to recommend similar items to the items that a user has liked in the past, and, in contrast, a collaborative approach that seeks to select items for a given user that similar users have also liked.

The content-based recommendation approach is rooted in information retrieval (IR) and case-based reasoning (CBR) research. The success of the content-based method relies on an ability to accurately represent recommendable items in terms of a suitable set of content features, and to represent user profile information in terms of a similar feature set. It is then a matter of ranking items for recommendation according to their similarity with a given user profile. The disadvantage of content-based recommendation methods is that this content description requirement can be problematic and time consuming. Another problem is that a user profile effectively delimits a region of the item-space from which all future recommendations will be drawn. Therefore, future recommendations will disadvantageously display only limited diversity. This is particularly problematic for new users since their recommendations will be based on the very limited set of items represented in their immature profiles.

The collaborative recommendation approach represents a newer alternative to the more traditional content based strategies. The basic idea is to go beyond the experience of an individual user profile, and instead to draw on the experiences of a population or community of users. Collaborative recommendation techniques look for correlations between users in terms of their ratings assigned to items in a user profile. The users that display the strongest rating correlation to the target user act as “recommendation partners”, and items that occur in their profiles (but not in the target user profile) can be recommended to the target user. In this way, items are recommended on the basis of user similarity rather than item similarity. Since explicit content representations are not needed during collaborative recommendation, the knowledge-engineering problem associated with content-based methods is lessened. More importantly, as the available user-base grows, so too can the quality of recommendations made by the collaborative strategy. By identifying closely correlated recommendation partners collaborative techniques can suggest items whose relevance to a target user is not limited to a small set of similar items.

Collaborative recommendation, however, does suffer from a number of significant drawbacks. Since collaborative recommendation techniques rely directly on the ratings of other users, it is not suitable for recommending new items or one-off items. This so-called latency problem is a serious limitation that may render a collaborative recommendation strategy inappropriate for a given application domain.

Collaborative recommendation can also prove to be unsatisfactory in dealing with what might be termed an unusual user. If a target profile contains only a small number of ratings or contains ratings for a set of items that nobody else has looked at, then it may not be possible to make a reliable recommendation using the collaborative technique.

Individually, the content-based and collaborative personalization methods suffer from a number of significant disadvantages as mentioned above. Moreover, these methods focus on determining the interest of individual users and generating, filtering and delivering content suitable to a particular individual user. There is therefore needed, however, a method and system for personalizing contents and services to be delivered to a group of members that do not share exactly the same interests.

### SUMMARY OF THE INVENTION

The present inventions meets these needs by providing a method and system for personalizing content and services for a group of members that do not share exactly the same interests, but do share common interests or locations, either physical or virtual. In accordance with the present invention, the method and system compiles the interests of members of a group sharing a physical or logical location in order to distill common, shared interests and to customize content provision and service delivery dynamically. The method and system according to the present invention are based on the assumption that the members of the group are identifiable individually and their interests are at least partially known.

In accordance with the present invention, the method and system expresses preferences of the individual members using a defined number of attributes for which all of said members have preferences. Group preferences are then determined from a summary in a virtual user profile. The virtual user profile contains value probabilities for every value of each attribute. To determine the content to be delivered to the group, a sum of the probabilities for the values associated with each attribute is calculated and normalized with respect to the number of attributes for each item, and the item having the highest probability is delivered.

The present invention also provides a method by which the selected content can be delivered to the group via multiple content delivery devices. This is accomplished by utilizing a display list that can be communicated among the available content delivery devices. Each content delivery device then determines the particular content to be delivered based on the display list and the virtual user profile.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a known method for delivering billboard content information to vehicle drivers;

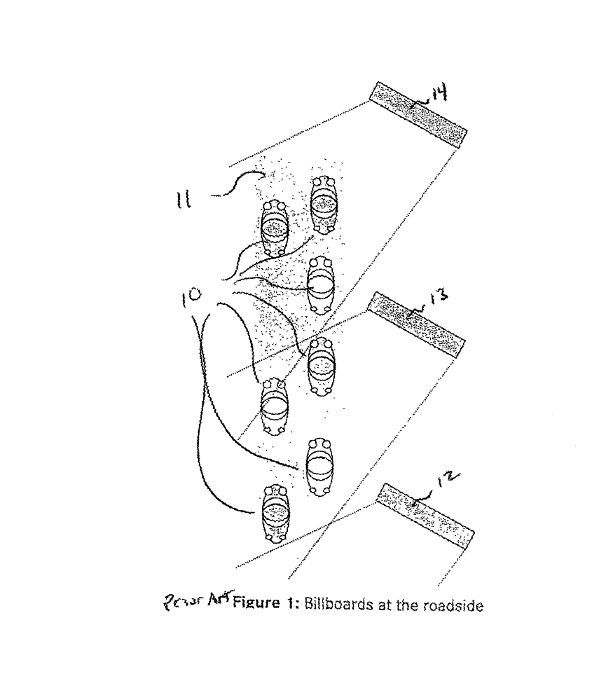

FIG. 2 is a flow chart illustrating the personalization cycle in a known personalization system for delivering content to a user;

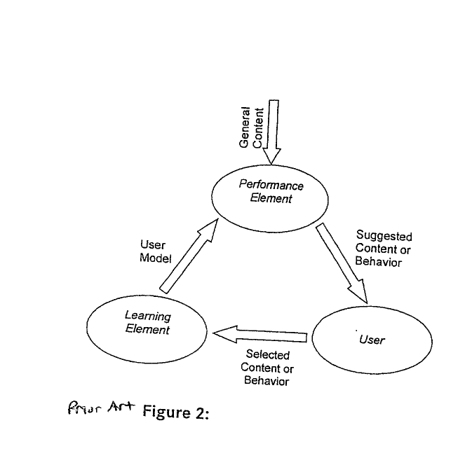

FIG. 3 is a table summarizing attribute preference values to define a virtual user profile for a group of members in accordance with the present invention;

FIG. 4 schematically illustrates, by way of example, the creation of a virtual user profile based on the individual value preferences of the members for certain defined attributes;

FIG. 5 is a table illustrating, by way of example, the evaluation of the appropriateness of each content item to be delivered;

FIG. 6 schematically illustrates the selection of a content item to be delivered to a group of members based on the virtual user profile; and

FIG. 7 schematically illustrates a method of delivering content via multiple content delivery devices to the group of members in accordance with a second embodiment of the invention.

### DETAILED DESCRIPTION OF THE INVENTION

The present invention makes use of the known i personalization techniques, which focus on understanding the preferences of an individual and determining the content and delivery mechanism that is suitable, to provide a novel means of selecting and delivering content for a group. Of course, if all the users (members) of the group shared exactly the same interest, then the group could be treated as a single virtual individual. Since that is rarely the case, the present invention provides a method and system for personalizing content to be delivered to a group of members by defining a virtual user profile.

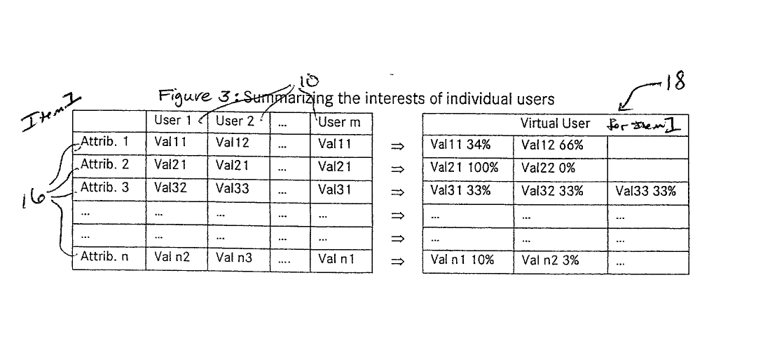

Referring to FIG. 3, assuming that the preferences of the users 10 (user 1 . . . user m) can be expressed using a fixed number of attributes 16 (Attrib. 1 . . . Attrib. n) and that all users have preferences for all attributes, the preferences of the group of users can be summarized in a profile for a virtual user 18. This virtual user 18 will have value probabilities for every value of each attribute. The value probabilities (Vₚ) are calculated by summing up the number of times the value was chosen (nᵥ) over the total number of users in the group (Nᵤ):

$${V}_{p} = \frac{{n}_{v}}{{N}_{u}} \qquad ( \text{Eq. 1} )$$

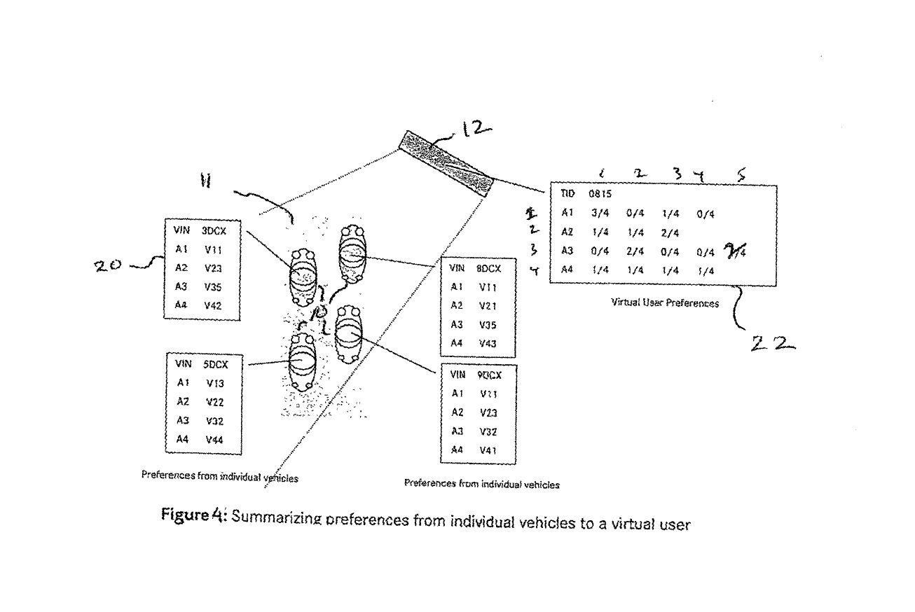

This can be seen in the example of FIG. 4 discussed below.

FIG. 4 illustrates four group members (drivers 10) traveling upon a roadway 11. A billboard 12 is arranged to the side of the roadway 11. Each driver 10 is shown having certain attribute preferences. For example, box 20 illustrates that one of the drivers 10 ascribes a preference value V11 to attribute A1, a preference value V23 to attribute A2, a preference value V35 to attribute A3, and a preference value V42 to attribute A4. The other drivers 10 similarly ascribe various preference values to the same step of attributes. In accordance with Equation 1, a virtual user profile 22 is obtained for the group of user drivers 10. The virtual user profile 22 contains value probabilities for every value of each attribute. For example, with respect to attribute A1, the value probability of value V11 is “¾” or 0.75 and the value probability of value V13 is “¼” or 0.25. Because none of the user drivers 10 preferred values V12 and V14 for attribute A1, the value probabilities for these values are zero.

If all members of the group choose the same value for an attribute, then the probability of that value will be one. To determine which item should be selected and displayed, in accordance with Equation 2, the sum of the probabilities for the values (Vⱼ) associated with each attribute (Aⱼ) is calculated and normalized with respect to the number of attributes (N_{A}) for each item:

$${G}_{I} = \frac{{\sum }_{j} {V}_{P} ( {A}_{j} )}{{N}_{A}} \qquad ( \text{Eq. 2} )$$

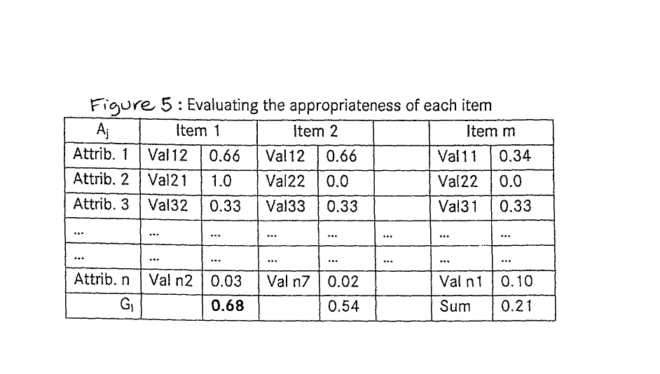

Referring to FIG. 5, the item with the highest probability sum G_{I} is then selected for display, which in this case would be Item 1.

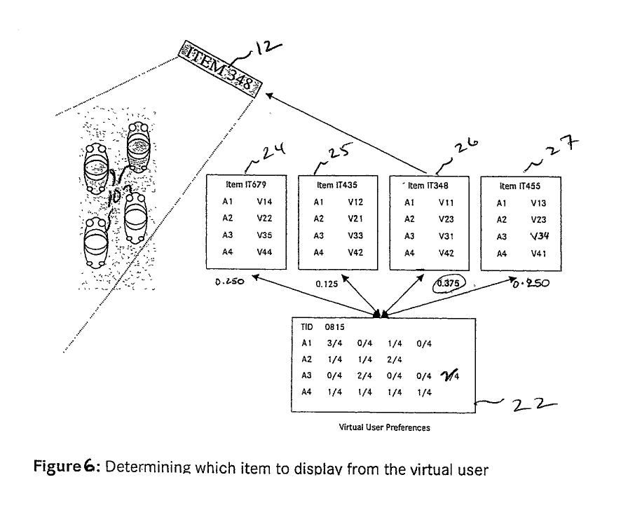

Referring to FIG. 6, again a schematic illustration of a group of members 10 is provided. Various items 24-27 are shown having different characteristic values for each attribute. Based on the virtual user profile 22, the item with the highest probability sum is determined. In this case, item 26 (IT348) has a probability sum of 0.375, which is higher than the probability sums for the other possible items. Accordingly, the method and system selects item 26 for display on the billboard 12 to the group of drivers 10.

The method can be carried out via hardware and/or software based systems, such as microprocessor-based computer systems, networks and/or global communications systems. These microprocessor-based systems can perform one or more of the functions of compiling the individual interest values of each group member into a virtual group member, selecting the content for the group of members that best fits the virtual group member, and delivering the selected content to the group of members. Moreover, these systems can operate or assist in determining the individual interest values of each group member for the various attributes.

In accordance with the invention, depending on the application or content to be delivered, repetition can be a benefit or may need to be avoided. In certain instances, it may be necessary or useful to select and deliver content to the user group via multiple delivery devices. Accordingly, as a feature of the present invention, a method and system is provided for delivering the content over multiple content delivery devices. A hand-over mechanism between the multiple content delivery devices is implemented to ensure continuity and to avoid undesirable content repetition.

To handle content repetition, delivery devices are configured to communicate with each other and pass on a list of the items that have been displayed by previous units, and items that should be displayed by future units. Also, the item descriptions contained in the display list can include links to items that have to be displayed later and the number of so-called “leap” displays.

Several scenarios may exist:

No content repetition: The next n units should not repeat content already displayed;

Content repetition required: The content needs to be repeated n times, potentially skipping some display units in between; and

Display related: Content related to already displayed information has to be displayed.

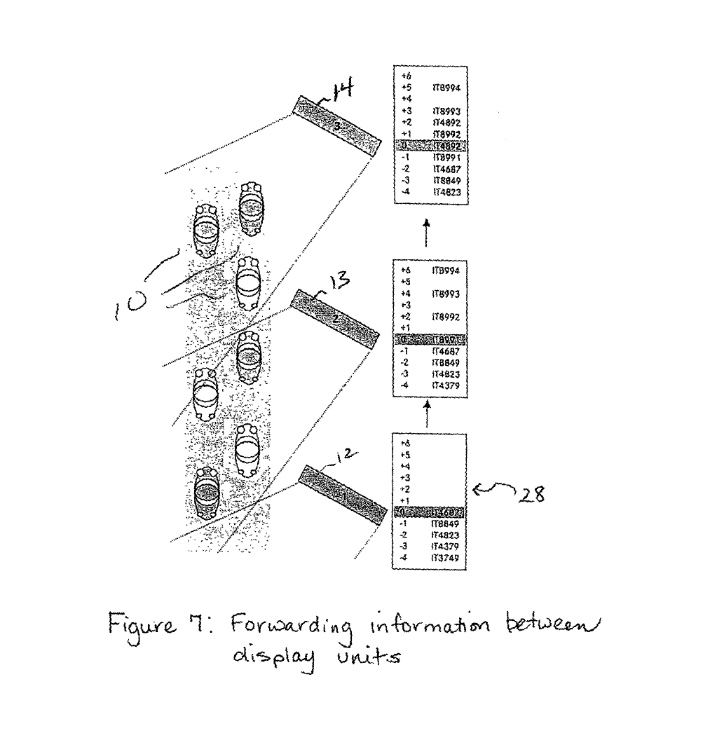

FIG. 7 depicts the forwarding of a display list 28 for these situations in accordance with the invention. The first display unit 12 received a display list that does not put a limit on the items that can be displayed. Based on the virtual user profile, the display unit 12 selects item IT4687 (shaded) to be displayed. The list is then forwarded to the next display unit 13.

Since no limitations regarding what should be displayed are forwarded, the second display unit 13 selects IT8991 (shaded) based on the virtual user profile. However, this item is part of a set of items (IT8991, IT8992, IT8993, IT8994) that need to be displayed after “leaping” or skipping one display unit. The display slots for the display units n+2, n+4 and n+6 are allocated accordingly.

The third display unit 14 selects item IT4892 (shaded). This item needs to be repeated twice with one display unit in between. Accordingly, it allocates slot n+2 with IT4892 as well.

When a display unit receives a predetermined item to be displayed, it has to verify that this item is still suitable for the current virtual user. Since each display unit continuously monitors its clientele, and re-calculates the preferences of the virtual user, it will evaluate the suitability of the proposed item. If the suitability is below a certain threshold, each display unit can override the suggested item and select something more suitable to the interests of the current member group.

While some content might be suitable for all audiences, some items should not be displayed to everybody. Items in this class could be advertisements for tobacco, alcoholic beverages, etc. While determining the suitability of items for the audience, the display units have to take restrictions such as the ones mentioned above into account.

Accordingly, a method and system is described to compile the interests of members of a group sharing a physical or logical location to distill common, shared interests and customize content provision and service delivery dynamically. The described invention is based on the assumption that members of the group can be identified individually and their interests are at least partially known. The customization of billboard ads at the side of a highway is just one example of an application scenario for the present invention.

The present invention is not limited to the embodiment described herein with respect to the delivery of billboard content to a group of user drivers operating on a roadway. The method and system can be applied for selecting content, services and other information for delivery to any group of members whose interests can be compiled and who share some physical or logical location.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of selecting content personalized for a group of members, the content being characterized by various attributes, the method comprising the acts of:
determining individual interest values of each group member for the various attributes;
compiling the individual interest values of each group member into a virtual group member; and
selecting the content for the group of members that best fits the virtual group member.

2. The method according to claim 1, further comprising the act of delivering the selected content to the group of members.

3. The method according to claim 1, wherein the act of compiling comprises the act of:
calculating, from the individual interest values, interest value probabilities for every interest value of each of the various attributes.

4. The method according to claim 3, wherein the act of selecting comprises the act of:
summing the interest value probabilities associated with each of the various attributes for the content to be selected;
normalizing the summed interest value probabilities with respect to the number of attributes for the content to be selected; and
selecting a particular content having the highest normalized probability sum from among the content to be selected.

5. The method according to claim 2, wherein the act of compiling comprises the act of:
calculating, from the individual interest values, interest value probabilities for every interest value of each of the various attributes.

6. The method according to claim 5, wherein the act of selecting comprises the act of:
summing the interest value probabilities associated with each of the various attributes for the content to be selected;
normalizing the summed interest value probabilities with respect to the number of attributes for the content to be selected; and
selecting a particular content having the highest normalized probability sum from among the content to be selected.

7. The method according to claim 2, wherein the act of delivering the selected content further comprises the act of linking multiple content delivery devices together via a communicable instruction display list containing selected content identifiers, each of the multiple content delivery devices displaying the selected content in accordance with the instruction display list.

8. A system for selecting content personalized for a group of members, the content being characterized by various attributes, the system comprising:
means for determining individual interest values of each group member for the various attributes;
means for compiling the individual interest values of each group member into a virtual group member; and
means for selecting the content for the group of members that best fits the virtual group member.

9. The system according to claim 8, further comprising a content delivering device which receives the selected content and is operatively arranged to deliver the selected content to the group of members.

10. The system according to claim 8, wherein the means for compiling comprises means for calculating, from the individual interest values, interest value probabilities for every interest value of each of the various attributes.

11. The system according to claim 10, wherein the means for selecting comprises:
means for summing the interest value probabilities associated with each of the various attributes for the content to be selected;
means for normalizing the summed interest value probabilities with respect to the number of attributes for the content to be selected; and
means for selecting a particular content having the highest normalized probability sum from among the content to be selected.

12. The system according to claim 91 wherein the content delivery device comprises multiple content delivery devices operatively linked together.

13. The system according to claim 12, further comprising means for handling the content to be delivered by the multiple content delivery devices.

14. The system according to claim 13, wherein the handling means is a display list communicated between the multiple content delivery devices, the display list containing content identifiers.

15. The system according to claim 9, wherein the content delivery device is a billboard, and the group of members comprise vehicle drivers passing the billboard.

16. The system according to claim 12, wherein the multiple content delivery devices are billboards, and the group of members comprise vehicle drivers passing the billboards.

17. The system according to claim 14, wherein the multiple content delivery devices are billboards, and the group of members comprise vehicle drivers passing the billboards.
